(19) United States
(12) Patent Application Publication
(10) Pub. No.: US 2020/0347195 A1
(43) Pub. Date: Nov. 5, 2020

(54) Polyolefin Films Having in-situ Formed Elongated Polyolefin Structures Therein

(71) Applicant: ExxonMobil Chemical Patents Inc., Baytown, TX (US)

(72) Inventors: Nino Ruocco, Houston, TX (US); Joseph A. Throckmorton, Kingwood, TX (US); Tamara L. Blanton, Nassau Bay, TX (US); Brain J. Rohde, Houston, TX (US)

(21) Appl. No.: 16/816,748

(22) Filed: Mar. 12, 2020

Related U.S. Application Data
(60) Provisional application No. 62/841,484, filed on May 1, 2019.

(51) Int. Cl. C08J 5/18; C08L 23/06; B29C 48/08; B29C 48/00; B29C 48/88; B29C 48/91

(52) U.S. Cl. CPC C08J 5/18; C08L 23/06; B29C 48/08; B29C 48/0018; B29C 48/9135; B29C 48/91; B29K 2105/0088; C08L 2205/03; C08L 2205/025; C08J 2323/06; C08J 2423/06; C08L 2203/16; B29C 48/022

(57) ABSTRACT

This invention relates to a method for forming a film including extruding the film from a polymer melt comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a polymer blend consisting of the first and second polyolefins in the same relative amounts as in the film has a multimodal differential scanning calorimetry melting profile above 40° C.; and stretching the film while the film is at a temperature above 25° C. and below the melting point of the second polyolefin to form elongated polyolefin structures in-situ in the film.

### CROSS-REFERENCE TO RELATED APPLICATIONS

This application claims the benefit of Ser. No. 62/841,484, filed May 1, 2019, the disclosure of which is hereby incorporated in its entirety.

### FIELD

This invention relates to films with elongated reinforcing structures therein.

### BACKGROUND

In film packaging and other industrial applications, elongated reinforcing structures (e.g., structures having an aspect ratio of 3 or greater) are often used to impart strength and stiffness to semi-crystalline materials like polyethylene. Examples of elongated reinforcing structures include cellulose, clay, and pre-formed elongated polymer structures.

Further, improvement in strength and stiffness can be observed when the elongated reinforcing structures are aligned. Forming films containing aligned elongated reinforcing structures involves combining a polymer with the elongated reinforcing structures and extruding the polymer composition into a film. Extrusion typically mechanically aligns the elongated reinforcing structures in the polymer matrix.

However, the improvement in strength and stiffness can be negatively impacted by incompatibility or poor compatibility between the polymer matrix and the elongated reinforcing structures. For example, if the polymer matrix and the elongated reinforcing structures are not compatible at their interface, there can be poor interaction between and poor load transfer from the polymer matrix to the elongated reinforcing structures.

One active area of research in improving the compatibility of and load transfer between the polymer matrix and the elongated reinforcing structures is to functionalize or coat the surface of the elongated reinforcing structures with moieties or compounds that improve that interface. However, this approach increases the cost and processing steps to produce the elongated reinforcing structures. Further, each polymer matrix can require a different surface treatment for the elongated reinforcing structures.

Alternative approaches to forming polymer films with elongated structures therein, preferably aligned, would be of value.

References of interest include: (a) Ruland W. (1969) “Small-Angle Scattering Studies on Carbonized Cellulose Fiberts,” J. Polymer Sci. Part C., No. 28, pp. 143-151; (b) Stribeck N. (2007) X-Ray Scattering of Soft Matter, Springer; (c) Liang, S. et al. (2008) “Unique Crystal Morphology and Tensile Properties of Injection-Molded Bar of LLDPE by Adding HDPE with Different Molecular Weights, Acta Materialia, v.56(1) pp. 50-59; (d) Tian, Y. et al. (2015) “Transition from Shish-Kebab to Fibrillar Crystals During Ultra-High Hot Stretching of Ultra-High Molecular Weight Polyethylene Fibers: In situ Small and Wide Angle X-Ray Scattering Studies,” European Polymer Journal, v.73, pp. 127-136; (e) Wang, Z. et al. (2017) “Structural Evolution from Shish-Kebab to Fibrillar Crystals During Hot-Stretching Process of Gel Spinning Ultra-High Molecular Weight Polyethylene Fibers Obtained from Low Concentration Solution,” Polymer, v.120, pp. 244-254, 201; (f) Milicevic, D. et al. (2012) “Microstructure and Crystallinity of Polyolefins Oriented via Solid-State Stretching at an Elevated Temperature,” Fibers and Polymers, v.13(4), pp. 466-470; (g) Tian, Y. et al. (2014) “Lamellae Break Induced Formation of Shish-Kebab During Hot Stretching of Ultra-High Molecular Weight Polyethylene Precursor Fibers Investigated by in situ Small Angle X-Ray Scattering,” Polymer, v.55(16), pp. 4299-4306; (h) Zheng, H. et al. (2015) “Fabrication of Polymer/Aligned Shish-Kebab Composite: Microstructure and Mechanical Properties,” RCS Advances, v.74, 27 pgs.; (j) International Patent Application Publication Nos. WO2019/038868 and WO1999/055775; (k) US Patent Application Publication Nos. 2017/0341353, 2017/0210890, 2011/0172354, and 2008/0114131; and (1) U.S. Pat. Nos. 5,185,199, 5,028,663, and 4,842,922.

### SUMMARY OF THE INVENTION

The present disclosure relates to film and methods of forming films that comprise elongated polyolefin structures that are formed in-situ. More specifically, the compositions and methods described herein use a two-polyolefin blend where each polyolefin has a similar molecular weight but different density. A film produced therefrom can then be heated and stretched to form elongated polyolefin structures therein.

The present disclosure includes a method comprising: extruding a film from a polymer melt comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a reference polymer blend consisting of the first and second polyolefins in the same relative amounts as in the film has a multimodal, typically bimodal, differential scanning calorimetry melting profile above 40° C.; and stretching the film while the film is at a temperature from 25° C. to below the melting point of the second polyolefin to form elongated polyolefin structures in-situ in the film.

The present disclosure also includes a film comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a reference polymer blend consisting of the first and second polyolefins in the same relative amounts as in the film has a multimodal, typically bimodal, differential scanning calorimetry melting profile at temperatures above 40° C.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-1C illustrate x-ray scattering patterns with a circular shape, an oblong shape, and a streaked shape, respectively.

FIG. 2 illustrates a non-limiting example of a system suitable for forming the films of the present disclosure having in-situ elongated polyolefin structures therein.

FIG. 3 is the DSC melting and crystallization profiles for the individual PolyA and PolyB and a blend of PolyA:PolyB at a weight ratio of 90:10.

FIG. 4 is a photograph of the final stretched specimen for the 90:10 specimen at the three temperatures investigated.

FIG. 5 includes a plot of the stress as a function of time during stretching of the specimen for the 90:10 specimen at 80° C. along with SAXS scattering pattern data corresponding to five time points during the stretching, during cooling, and after cooling.

FIG. 6 is a plot of the stress as a function of time during stretching of the specimen for the 90:10 specimen at the three stretching temperatures.

FIG. 7A includes representative 2-D and 3-D phase 2 AFM scans of the 25° C. stretched specimen. FIG. 7B includes representative 2-D and 3-D phase 2 AFM scans of the 70° C. stretched specimen. FIG. 7C includes representative 2-D and 3-D phase 2 AFM scans of the 80° C. stretched specimen.

### DETAILED DESCRIPTION

The compositions and methods described herein use a two-polyolefin blend where each polyolefin has a similar molecular weight but different density. A film produced therefrom can then be heated and stretched to form elongated polyolefin structures therein. More specifically, the first polyolefin (the major component) is a lower density polyolefin than the second polyolefin (the minor component). Further, the higher density for the second polyolefin should be such that the polymer melt of the first and second polyolefins has a multimodal, typically bimodal, differential scanning calorimetry (DSC) melting profile at temperatures above 40° C. Without being limited by theory, it is believed that during heating and stretching of the film, the second, higher density polyolefin remains crystalline while the first, lower density polyethylene softens. The crystalline, second, higher density polyolefin then is thought to act as a nucleation and/or growth site where, as the first, lower density polyethylene cools, it crystallizes around the crystalline, second, higher density polyolefin to form elongated polyolefin structures in the film in-situ. The size and orientation of the elongated polyolefin structures depend on the temperature during stretching and degree of stretching.

Further, without being limited by theory, it is believed that the elongated polyolefin structures impart strength to the film much like an elongated filler particle would if included in the original polymer melt. However, in this instance, because the elongated polyolefin structures are formed in-situ, the size, orientation, and other properties of the elongated polyolefin structures can be tailored based on the properties of the two polyolefins, the temperature of stretching, and the degree of stretching. Therefore, advantageously, a variety of fillers to include in the polymer melt are not needed, instead, commercial film stretching machines can be modified to tailor the elongated polyolefin structures and film property.

### Definitions and Test Methods

Unless otherwise indicated, room temperature is 25° C.

An “olefin,” alternatively referred to as “alkene,” is a linear, branched, or cyclic compound of carbon and hydrogen having at least one double bond.

A “polymer” has two or more of the same or different mer units. A “homopolymer” is a polymer having mer units that are the same. The term “polymer” as used herein includes, but is not limited to, homopolymers, copolymers, terpolymers, etc. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, unless specified otherwise, the term “copolymer(s)” refers to polymers formed by the polymerization of at least two different monomers (i.e., mer units). For example, the term “copolymer” includes the copolymerization reaction product of propylene and an alpha-olefin, such as ethylene, 1-hexene. A “terpolymer” is a polymer having three mer units that are different from each other. Thus, the term “copolymer” is also inclusive terpolymers and tetrapolymers, such as, for example, the copolymerization product of a mixture of ethylene, propylene, 1-hexene, and 1-octene.

“Different” as used to refer to monomer mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

As used herein, when a polymer is referred to as “comprising, consisting of, or consisting essentially of” a monomer, the monomer is present in the polymer in the polymerized form of the monomer or is the derivative form of the monomer. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

Density in g/cm³ is determined in accordance with ASTM 1505-10 and molded based on ASTM D4703-10a, procedure C, plaque preparation. A plaque is made and conditioned for at least forty hours at 23° C. to approach equilibrium crystallinity, measurement for density is then made in a density gradient column

As used herein, Mn is number average molecular weight, Mw is weight average molecular weight, and Mz is z-average molecular weight. Polydispersity index (PDI) is defined to be Mw divided by Mn. Unless otherwise noted, all molecular weights (e.g., Mw, Mn, Mz) are reported in units of g/mol. Molecular weight distribution is a graph of the concentration of polymer as a function of molecular weight.

GPC is a liquid chromatography technique widely used to measure the molecular weight, molecular weight distribution, and polydispersity) of polymers. This is a common and well-known technique. Such characteristics, as described here, can be measured using the techniques described below.

Unless otherwise indicated, the distribution and the moments of molecular weight (e.g., Mw, Mn, Mz, Mw/Mn) and the comonomer content (e.g., C₂, C₃, C₆) can be determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns can be used to provide polymer separation. Aldrich reagent grade 1,2,4-trichlorobenzene (TCB) with 300 ppm antioxidant butylated hydroxytoluene (BHT) can be used as the mobile phase. The TCB mixture can be filtered through a 0.1-pm Teflon filter and degassed with an online degasser before entering the GPC instrument. The nominal flow rate can be 1.0 mL/min, and the nominal injection volume can be 200 μL. The whole system including transfer lines, columns, and detectors can be contained in an oven maintained at 145° C. The polymer sample can be weighed and sealed in a standard vial with 80-μL flow marker (heptane) added to it. After loading the vial in the autosampler, polymer can be automatically dissolved in the instrument with 8 mL added TCB solvent. The polymer can be dissolved at 160° C. with continuous shaking for about 1 hour for most polyethylene samples or 2 hour for polypropylene samples. The TCB densities used in concentration calculation can be 1.463 g/ml at room temperature and 1.284 g/mL at 145° C. The sample solution concentration can be from 0.2 to 2.0 mg/mL, with lower concentrations being used for higher molecular weight samples. The concentration (c), at each point in the chromatogram can be calculated from the baseline-subtracted IR5 broadband signal intensity (I), using the following equation: c=ρI, where β is the mass constant. The mass recovery can be calculated from the ratio of the integrated area of the concentration chromatography over elution volume and the injection mass, which is equal to the pre-determined concentration multiplied by injection loop volume. The conventional molecular weight (IR molecular weight) can be determined by combining universal calibration relationship with the column calibration, which can be performed with a series of monodispersed polystyrene (PS) standards ranging from 700 to 10,000,000 gm/mole. The molecular weight at each elution volume can be calculated with (1):

$$log M = \frac{log ( {K}_{PS} \text{/} K )}{a + 1} + \frac{{a}_{PS} + 1}{a + 1} log {M}_{PS} \qquad EQ . 1$$

where the variables with subscript “PS” stand for polystyrene while those without a subscript are for the test samples. In this method, α_{PS}=0.67 and K_{PS}=0.000175 while a and K are for other materials as calculated and published in literature (Sun, T. et al. (2001) “Effect of Short Chain Branching on the Coil Dimensions of Polyolefins in Dilute Solution,” Macromolecules, v.34, pp. 6812-6820), except that for purposes of this invention and claims thereto, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1-0.0087*w2b+0.000018*(w2b)\hat{ }2) for ethylene-butene copolymer where w2b is a bulk weight percent of butene comonomer, α is 0.695 and K is 0.000579*(1-0.0075*w2b) for ethylene-hexene copolymer where w2b is a bulk weight percent of hexene comonomer, and a is 0.695 and K is 0.000579*(1-0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The comonomer composition can be determined by the ratio of the IR5 detector intensity corresponding to CH₂ and CH₃ channel calibrated with a series of polyethylene and propylene homo/copolymer standards whose nominal value are predetermined by NMR or FTIR. In particular, this provides the methyls per 1,000 total carbons (CH3/1000TC) as a function of molecular weight. The short-chain branch (SCB) content per 1000TC (SCB/1000TC) can be then computed as a function of molecular weight by applying a chain-end correction to the CH₃/1000TC function, assuming each chain to be linear and terminated by a methyl group at each end. The weight % comonomer can be then obtained from the following expression in which f is 0.3, 0.4, 0.6, 0.8, and so on for C₃, C₄, C₆, C₈, and so on co-monomers, respectively:

w2=f* SCB/1000TC EQ. 2.

The bulk composition of the polymer from the GPC-IR and GPC-4D analyses can be obtained by considering the entire signals of the CH₃ and CH₂ channels between the integration limits of the concentration chromatogram. First, the following ratio is obtained.

$$Bulk IR ratio = \frac{Area of {CH}_{3} signal within integration limits}{Area of {CH}_{2} signal within integration limits} \qquad EQ . 3$$

Then the same calibration of the CH₃ and CH₂ signal ratio, as mentioned previously in obtaining the CH₃/1000TC as a function of molecular weight, can be applied to obtain the bulk CH3/1000TC. A bulk methyl chain ends per 1000TC (bulk CH₃end/1000TC) can be obtained by weight-averaging the chain-end correction over the molecular-weight range. Then,

w2b=f* bulk CH3/1000TC EQ. 4

bulk SCB/1000TC=bulk CH3/1000TC−bulk CH3end/1000TC EQ. 5

and bulk SCB/1000TC can be converted to bulk w2 in the same manner as described above.

The LS detector can be the 18-angle Wyatt Technology High Temperature DAWN HELEOSII. The LS molecular weight (M) at each point in the chromatogram can be determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c \qquad EQ . 6$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn \text{/} dc )}^{2}}{{λ}^{4} {N}_{A}} {K}_{o} = \frac{4 {π}^{2} {{n}^{2} ( dn \text{/} dc )}^{2}}{{λ}^{4} {N}_{A}} \qquad EQ . 7$$

where N_{A} is Avogadro's number, and (dn/dc) is the refractive index increment for the system. The refractive index, n=1.500 for TCB at 145° C. and λ=665 nm. For analyzing ethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1-0.00126*w2) ml/mg and A₂=0.0015 where w2 is weight percent butene comonomer.

A high temperature Viscotek Corporation viscometer, which has four capillaries arranged in a Wheatstone bridge configuration with two pressure transducers, can be used to determine specific viscosity. One transducer measures the total pressure drop across the detector, and the other, positioned between the two sides of the bridge, measures a differential pressure. The specific viscosity, hₛ, for the solution flowing through the viscometer is calculated from their outputs. The intrinsic viscosity, [h], at each point in the chromatogram is calculated from the following equation:

ηₛ=c[η]+0.3(c[η])²,

where c is concentration and was determined from the DRI output.

The branching index (g′ᵥᵢₛ) is calculated using the output of the GPC-DRI-LS-VIS method as follows. The average intrinsic viscosity, [h]_{avg} of the sample is calculated by:

$${[ η ]}_{avg} = \frac{Σ {{c}_{i} [ η ]}_{i}}{Σ {c}_{i}} ,$$

where the summations are over the chromatographic slices, i, between the integration limits.

The branching index g′ᵥᵢₛ is defined as:

$${g}^{′} vis = \frac{{[ η ]}_{avg}}{{kM}_{v}^{α}} .$$

Mᵥ is the viscosity-average molecular weight based on molecular weights determined by LS analysis. Z average branching index (g′zₐᵥₑ) is calculated using Ci=polymer concentration in the slice i in the polymer peak times the mass of the slice squared, Mi². All molecular weights are weight average unless otherwise noted. All molecular weights are reported in g/mol unless otherwise noted. This method is the preferred method of measurement and used in the examples and throughout the disclosures unless otherwise specified. See also, Sun, T. et al. (2001) “Effect of Short Chain Branching on the Coil Dimensions of Polyolefins in Dilute Solution,” Macromolecules, v.34, pp. 6812-6820.

A high temperature viscometer, such as those made by Technologies, Inc. or Viscotek Corporation, which has four capillaries arranged in a Wheatstone bridge configuration with two pressure transducers, can be used to determine specific viscosity. One transducer measures the total pressure drop across the detector, and the other, positioned between the two sides of the bridge, measures a differential pressure. The specific viscosity, η_{S}, for the solution flowing through the viscometer can be calculated from their outputs. The intrinsic viscosity, [η], at each point in the chromatogram can be calculated from the equation [η]=η_{S}/c, where c is concentration and is determined from the IR5 broadband channel output. The viscosity molecular weight at each point is calculated as M=K_{PS}M^{α}^{_{PS}}⁺¹/[η], where αₚₛ is 0.67 and Kₚₛ is 0.000175.

As used herein, a “peak” occurs where the first derivative of the corresponding curve changes sign from positive value to negative value. As used herein, a “valley” occurs where the first derivative of the corresponding curve changes from a negative value to a positive value.

As used herein, a “mode” is a local minimum or local maximum depending on the measurement and plotting. Molecular weights are plotted as molecular weight (g/mol or kg/mol) (x-axis) versus number of molecules (y-axis). Accordingly, modes for molecular weight are peaks. Differential scanning calorimetry (DSC) measurements, from which melting point or melting temperature (Tm) and crystallization temperature (Tc) are derived, are plotted as temperature (x-axis) versus heat flow (W/g) (y-axis). Because melting temperatures occur at reductions in heat flow during heating, melting temperature modes are valleys on the DSC plot. Because crystallization temperature occur at higher heat flow during cooling, crystallization temperature modes are peaks on the DSC plot.

The plots from which the modes are determined typically exclude lower x-values because of noise. Modes for molecular weight plots are identified above a molecular weight of 5,000 g/mol. Modes for DSC plots (melting or crystallization) are identified above a temperature of 40° C.

As used herein, “multimodal” is a plot having two or more modes. As used herein, “monomodal” is a plot having one mode. As used herein, “bimodal” is a plot having two modes.

Melt flow index (MFI) or I₂ was measured according on a Goettfert MI-4 Melt Indexer. Testing conditions were set at 190° C. and 2.16 kg load. An amount of 5 g to 6 g of sample was loaded into the barrel of the instrument at 190° C. and manually compressed. Afterwards, the material was automatically compacted into the barrel by lowering all available weights onto the piston to remove all air bubbles. Data acquisition was started after a 6 min pre-melting time. Also, the sample was pressed through a die of 8 mm length and 2.095 mm diameter.

Heavy load melt flow index (HLMFI) or I₂₁ is determined according to ASTM D-1238-E (190° C/21.6 kg).

Melt index ratio (MIR) is the ratio of I₂₁/I₂.

The differential scanning calorimetry (DSC) measurements were performed with TA Instruments' Discovery 2500. Melting point or melting temperature (Tm), crystallization temperature (Tc), and heat of fusion or heat flow (ΔH_{f}or H_{f}) were determined using the following DSC procedure. Samples weighing approximately 2 mg to 5 mg were carefully sealed in aluminum hermetic pan. Heat flow was normalized with the sample mass. The DSC runs were ramped up from 0° C. at 10° C./min to 200° C., after equilibration for 45 sec, the samples were cooled down at 5° C./min to 0° C. Both first and second thermal cycles were recorded. Unless otherwise specified, DSC measurements are based on the 2^{nd} crystallization and melting ramps. The melting temperature (Tₘ) and crystallization temperature (Tₑ) were calculated by integrating the melting and crystallization peaks (area below the curves).

As used herein, the terms “machine direction” and “MD” refers to the stretch direction in the plane of the film.

Small angle x-ray scattering (SAXS) data was collected at beamline 12-ID-B. The x-ray beam was point collimated and passed through a capillary optic before contacting the sample. The x-ray beam energy was set to 14keV corresponding to a wavelength of 0.8856 Å-1. Samples were stretched with a Linkam TST450 tensile stage and after being placed in the sample holder at room temperature were preheated to the desired temperature before stretching. The SAXS data was collected on a Dectris Pilatus 2M (pixel size 172 μm) at a distance of 2.019 m from the sample.

The Ruland streak method for analyzing SAXS is described in Ruland W. (1969) “Small-Angle Scattering Studies on Carbonized Cellulose Fibers,” J. Polymer Sci. Part C., No. 28, pp. 143-151 and Stribeck N. (2007) X-Ray Scattering of Soft Mater, Springer. Briefly, the integrated width of the angular distribution of the scattered intensity (B_{obs}) is used to estimate the true width of the orientation distribution (B_{φ}) (misorientation) and the average length (L) of the elongated polyolefin structures aligned in the machine direction. The azimuthally distributed scans of intensities at different scattering vector (q) values are analyzed using the Lorentz function to yield the average width of the angular distribution. The width of the equatorial streaks in the reciprocal space can be related to obtain the length of the elongated polyolefin structures. The relationship between the L and B_{ϕ}, can be approximated as EQ. 8

$${B}_{obs} = \frac{2 π}{L q} + {B}_{ϕ} \qquad EQ . 8$$

The elongated polyolefin structures' length (L) and degree of misorientation (B_{ϕ}) are determined by the linear least square fitting (XPolar software, available from Precision Works) applied to the data. In the relation,

$$q = \frac{4 π sin θ}{λ}$$

(where θ is the scattering angle, q is the scattering vector, and λ is the wavelength).

As used herein, a “continuous phase” of a film is the portion of the material phase in which a “discontinuous phase” is dispersed.

As used herein, the term “extruding” and grammatical variations thereof refer to processes that includes forming a polymer and/or polymer blend into a melt, such as by heating and/or sheer forces, and then forcing the melt out of a die in a desirable form or shape such as in a film. Most any type of apparatus will be appropriate to effect extrusion such as a single or twin-screw extruder, or other melt-blending device as is known in the art and that can be fitted with a suitable die.

### Films and Methods

The films described herein comprise (1) a continuous phase that comprises a first polyolefin and (2) a discontinuous phase of elongated polyolefin structures that comprise a second polyolefin. The second polyolefin can be present in the film at about 0.1 wt % to about 30 wt %, or about 1 wt % to about 20 wt %, or about 5 wt % to about 15 wt %, or about 0.1 wt % to about 15 wt % based on the total weight of the first polyolefin and the second polyolefin. The second polyolefin has a density of at least 0.04 g/cm³ greater than a density of the first polyolefin; a melt flow index (190° C., 2.16 kg) of the first polyolefin is within 25% of a melt flow index (190° C., 2.16 kg) of the second polyolefin; and a reference polymer blend consisting of the first and second polyolefins in the same relative amounts as in the film has a multimodal, such as bimodal, DSC melting profile above 40° C.

Methods of producing such films can comprise: extruding a film from a polymer melt comprising the first polyolefin and 0.1 wt % to 30 wt % of the second polyolefin; and stretching the film while the film is at a temperature from 25° C. to below the melting point of the second polyolefin to form the elongated polyolefin structures in-situ in the film.

The first polyolefin described herein is a major component of the polymeric composition of the film. The first polyolefin can be present at about 70 wt % to about 99.9 wt % or about 99 wt % to about 80 wt %, or about 95 wt % to about 85 wt %, or about 99.9 wt % to about 85 wt % relative to the combined first and second polyolefin weight of the polymeric composition.

The second polyolefin described herein is a minor component of the polymeric composition of the film. The second polyolefin can be present at about 0.1 wt % to about 30 wt %, or about 1 wt % to about 20 wt %, or about 5 wt % to about 15 wt %, or about 0.1 wt % to about 15 wt % relative to the combined first and second polyolefin weight of the polymeric composition.

The first and second polyolefins are preferably similar in molecular weight.

Without being limited by theory, it is believed that having the MFIs of the two polyolefins within 25% (or within 20%, or within 15%, or within 10%, or within 5%) provides a similar enough molecular weight that the two polyolefins blend homogeneously. As used herein, a “homogeneous” blend refers to a blend of polymers that do not phase separate when mixing the molten polymers and during the initial extrusion at film forming conditions.

Melt flow index (MFI) provides an indication of molecular weight of a polyolefin. For the methods and compositions described herein, the melt flow index of the first polyolefin (MFI_{P1}) is within 25% of the melt flow index of the second polyolefin (MFI_{P2}) as described in EQ. 9.

$$\frac{\vert {MFI}_{P 2} - {MFI}_{P 1} \vert}{{MFI}_{P 2}} * 100 \leq 25 \% \qquad EQ . 9$$

An alternative way to characterize the molecular weight of the two polyolefins is by molecular weight distribution of the blend of the two polyolefins. For example, the blend of the two polyolefins at the relative concentrations as in the film can optionally have a monomodal plot of molecular weight (or a monomodal molecular weight distribution). Without being limited by theory, the lower concentration of the second polyolefin and similar molecular weights of the first and second polyolefins provide a good dispersion of the second polyolefin throughout the polymer melt so that individual elongated polyolefin structures can be formed.

Examples of first polyolefins include, but are not limited to, ethylene homopolymers, propylene homopolymers, ethylene copolymers, propylene copolymers, and the like, and any combination thereof that comport with the prescribed density, melt flow index, and multimodal, preferably bimodal, DSC melting profile.

Examples of second polyolefins include, but are not limited to, ethylene homopolymers, propylene homopolymers, ethylene copolymers, propylene copolymers, and the like, and any combination thereof that comport with the prescribed density, melt flow index, and multimodal, preferably bimodal, DSC melting profile.

Ethylene copolymers typically comprises 51 wt % to 98 wt % (or 51 wt % to 70 wt %, or 60 wt % to 80 wt %, or 75 wt % to 95 wt %, or 90 wt % to 98 w%) of polymer units derived from ethylene, 2 wt % to 49 wt % (or 2 wt % to 10 wt %, or 5 wt % to 25 wt %, or 20 wt % to 40 wt %, or 30 wt % to 49 wt %) of polymer units derived from one or more C3 to C20 alpha-olefin comonomers, and 0 wt % to 10 wt % (or 0 wt %, or 0 wt % to 5 wt %, or 1 wt % to 6 wt %, or 3 wt % to 8 wt %, or 5 wt % to 10 wt %) polymer units derived from a diene, based upon total weight of the ethylene copolymer.

Propylene copolymers typically comprise 51 wt % to 98 wt % (or 51 wt % to 70 wt %, or 60 wt % to 80 wt %, or 75 wt % to 95 wt %, or 90 wt % to 98 w%) of polymer units derived from propylene, 2 wt % to 49 wt % (or 2 wt % to 10 wt %, or 5 wt % to 25 wt %, or 20 wt % to 40 wt %, or 30 wt % to 49 wt %) of polymer units derived from one or more ethylene and/or C₄ to C₂₀ alpha-olefin comonomers, and 0 wt % to 10 wt % (or 0 wt %, or 0 wt % to 5 wt %, or 1 wt % to 6 wt %, or 3 wt % to 8 wt %, or 5 wt % to 10 wt %) polymer units derived from a diene, based upon total weight of the propylene copolymer.

The diene may be any hydrocarbon structure having at least two unsaturated bonds wherein at least one of the unsaturated bonds is readily incorporated into a polymer. Examples of dienes include, but are not limited to, straight chain acyclic olefins such as 1,4-hexadiene and 1,6-octadiene; branched chain acyclic olefins such as 5-methyl-1,4-hexadiene, 3,7-dimethyl-1,6-octadiene, and 3,7-dimethyl-1,7-octadiene; single ring alicyclic olefins such as 1,4-cyclohexadiene, 1,5-cyclooctadiene, and 1,7-cyclododecadiene; multi-ring alicyclic fused and bridged ring olefins such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene.

Preferably, the first and second polyolefins are the same type of polyolefin. For example, the first and second polyolefins may both be ethylene homopolymers that each comport with the prescribed density, melt flow index, and multimodal, such as bimodal, DSC melting profile. In another example, the first and second polyolefins may both be propylene homopolymers that each comport with the prescribed density, melt flow index, and multimodal, such as bimodal, DSC melting profile. However, the first and second polyolefins may be different types of polyolefins. For example, the first polyolefin may be an ethylene homopolymer or an ethylene copolymer, and the second polyolefin may be a propylene homopolymer or a propylene copolymer (or vice versa), where each of the first and second polyolefins comport with the prescribed density, melt flow index, and multimodal, such as bimodal, DSC melting profile. In yet another example, the first polyolefin may be an ethylene homopolymer, and the second polyolefin may be an ethylene copolymer (or vice versa), where each of the first and second polyolefins comport with the prescribed density, melt flow index, and multimodal, such as bimodal, DSC melting profile. In another example, the first polyolefin may be a propylene homopolymer, and the second polyolefin may be a propylene copolymer (or vice versa), where each of the first and second polyolefins comport with the prescribed density, melt flow index, and multimodal, such as bimodal, DSC melting profile. In addition to the prescribed density, melt flow index, and multimodal, such as bimodal, DSC melting profile, preferably the first and second polyolefins are compatible so that a homogenous blend is achieved before casting the film.

In a preferred embodiment, both the first and second polyolefin are ethylene polymers. In a preferred embodiment, both the first and second polyolefin are propylene polymers.

In a preferred embodiment, the ethylene polymers useful herein are selected from ethylene homopolymers and ethylene copolymers. The method of making the ethylene polymers is not critical, as it can be made by slurry, solution, gas phase, high pressure, or other suitable processes, and by using catalyst systems appropriate for the polymerization of polyethylenes, such as Ziegler-Natta-type catalysts, chromium catalysts, metallocene-type catalysts, other appropriate catalyst systems, or combinations thereof, or by free-radical polymerization. In a preferred embodiment, the ethylene polymers are made by the catalysts, activators, and processes described in U.S. Pat. Nos. 6,342,566; 6,384,142; 5,741,563; PCT publications WO 2003/040201; and WO 1997/019991. Such catalysts are well known in the art, and are described in, for example, Ziegler Catalysts (Gerhard Fink, Rolf Millhaupt and Hans H. Brintzinger, eds., Springer-Verlag 1995); Resconi et al.; and I, II Metallocene-Based Polyolefins (Wiley & Sons 2000).

In a useful aspect, the ethylene polymers are metallocene polyethylenes (mPEs).

In another embodiment, the ethylene copolymer comprises one or more mPEs, such as those described in US Patent Application Publication No. 2007/0260016, U.S. Pat. Nos. 6,476,171, and 6,255,426.

In another embodiment, the ethylene polymer comprises a Ziegler-Natta polyethylene.

In another embodiment, the ethylene polymer is produced using chrome based catalysts, such as, for example, in U.S. Pat. No. 7,491,776, including that fluorocarbon does not have to be used in the production. Commercial examples of polymers produced by chromium include the PAXON™ grades of polyethylene produced by ExxonMobil Chemical Company, Houston Tex.

In another embodiment, the ethylene polymer comprises substantially linear and linear ethylene polymers (SLEPs). Substantially linear ethylene polymers and linear ethylene polymers and their method of preparation are fully described in U.S. Pat. Nos. 5,272,236; 5,278,272; 3,645,992; 4,937,299; 4,701,432; 4,937,301; 4,935,397; 5,055,438; EP 129,368; EP 260,999; and WO 1990/007526, which are fully incorporated herein by reference. As used herein, “a linear or substantially linear ethylene polymer” means a homopolymer of ethylene or a copolymer of ethylene and one or more alpha-olefin comonomers having a linear backbone (i.e. no cross linking), a specific and limited amount of long-chain branching or no long-chain branching, a narrow molecular weight distribution, a narrow composition distribution (e.g., for alpha-olefin copolymers) or a combination thereof. More explanation of such polymers is discussed in U.S. Pat. No. 6,403,692, which is incorporated herein by reference for all purposes.

In an aspect, the ethylene polymers is produced by gas-phase polymerization of ethylene and, optionally, an C₃ to C₂₀ alpha-olefin using transition metal catalyst(s), such as traditional Ziegler-Natta catalysts or metallocene catalysts, useful examples include bis(n-C₃₋₄ alkyl cyclopentadienyl) hafniumX₂, or(cyclopentadienyl)(propyl,tetramethyl-cyclopentadienyl)hafniumX₂, where X is a leaving group, such as halogen or C₁ to C₂₀alkyl. (As used herein, the term “metallocene catalyst” refers to a catalyst having at least one transition metal compound containing one or more substituted or unsubstituted Cp moiety (typically two Cp moieties) in combination with a Group 4, 5, or 6 transition metal.

An exemplary process used to polymerize ethylene-based polymers, such as LLDPEs, is as described in U.S. Pat. Nos. 6,936,675 and 6,528,597.

Preferred ethylene polymers and copolymers that are useful in this invention include those sold by ExxonMobil Chemical Company in Houston Tex., including those sold as EXXONMOBIL™ HDPE, EXXONMOBIL™ LLDPE, and EXXONMOBIL™ LDPE; and those sold under the ENABLE™, EXACT™, EXCEED™, ESCORENE™, EXXCO™ ESCOR™, PAXON™, and OPTEMA™ tradenames Particularly useful grades include EXCEED™ 1018 LLDPE, ENABLE™ 2010 polyethylene, and the LDPE™ 103 series.

The first polyolefin may have a density of 0.850 g/cm³ to 0.930 g/cm³, or 0.860 g/cm³ to 0.910 g/cm³, or 0.880 g/cm³ to 0.900 g/cm³. The second polyolefin may have a density of 0.890 g/cm³ to 0.970 g/cm³, or 0.910 g/cm³ to 0.970 g/cm³, or 0.930 g/cm³ to 0.960 g/cm³. The foregoing densities should be chosen such that the second polyolefin has a density of at least 0.04 g/cm³, or at least 0.055 g/cm³, or 0.04 g/cm³ to 0.12 g/cm³, or 0.05 g/cm³ to 0.10 g/cm³ greater than a density of the first polyolefin.

The first and second polyolefins may independently have a melt flow index of 0.2 g/10 min to 10 g/10 min, or of 0.4 g/10 min to 6 g/10 min, or of 0.5 g/10 min to 3 g/10 min such that the melt flow index of the first polyolefin is within 25%, or within 0% to 25%, (0% meaning the melt flow indices are the same), or within 0.01% to 25%, or within 1% to 20%, or within 10% to 15%or within 5% to 10%, preferably within 0% to 5% of a melt flow index of the second polyolefin.

A reference polymer blend consisting of the first and second polyolefins in the same relative amounts as in the film has a multimodal, such as bimodal, DSC melting profile above 40° C., or above 50° C., or above 60° C., or above 70° C., or above 80° C. That is, all of the Tms are above 40° C., or above 50° C., or above 60° C., or above 70° C., or above 80° C. For example, in a bimodal DSC melting profile, the lower melting temperature (Tm) of the bimodal DSC melting profile is above 40° C., or above 50° C., or above 60° C., or above 70° C., or above 80° C. For example in such a polymer blend, a melting peak corresponding to the first polyolefin may be at about 50° C. to about 180° C., or about 60° C. to about 175° C., or about 70° C. to about 170° C.; and a melting peak corresponding to the second polyolefin may be at about 80° C. to about 200° C., or about 90° C. to about 190° C., or about 100° C. to about 185° C. Further, in such a polymer blend, the melting peak of the second polyolefin minus the melting peak of the first polyolefin may be about 25° C. to about 100° C., or about 35° C. to about 85° C., or about 45° C. to about 65° C.

In another example using two polyethylenes, in a bimodal DSC melting profile, the lower melting temperature (Tm) of the bimodal DSC melting profile is above 40° C., or above 50° C., or above 60° C., or above 70° C., or above 80° C. For example in such a polymer blend, a melting peak corresponding to the first polyethylene may be at about 50° C. to about 100° C., or about 60° C. to about 95° C., or about 70° C. to about 90° C.; and a melting peak corresponding to the second polyethylene may be at about 80° C. to about 150° C., or about 90° C. to about 145° C., or about 100° C. to about 140° C. Further, in such a polymer blend, the melting peak of the second polyethylene minus the melting peak of the first polyethylene may be about 25° C. to about 100° C., or about 35° C. to about 85° C., or about 45° C. to about 65° C.

In yet another example using two polypropylenes, in a bimodal DSC melting profile, the lower melting temperature (Tm) of the bimodal DSC melting profile is above 70° C., or above 90° C., or above 110° C. For example in such a polymer blend, a melting peak corresponding to the first polypropylene may be at about 70° C. to about 180° C., or about 90° C. to about 175° C., or about 100° C. to about 170° C.; and a melting peak corresponding to the second polypropylene may be at about 100° C. to about 200° C., or about 120° C. to about 190° C., or about 140° C. to about 185° C. Further, in such a polymer blend, the melting peak of the second polypropylene minus the melting peak of the first polypropylene may be about 25° C. to about 100° C., or about 35° C. to about 85° C., or about 45° C. to about 65° C.

Optionally, the polyolefin film and/or polyolefin melt can further comprise additives. Examples of additives include, but are not limited to, stabilization agents (e.g., antioxidants or other heat or light stabilizers), anti-static agents, crosslink agents or co-agents, crosslink promoters, release agents, adhesion promoters, plasticizers, anti-agglomeration agents (e.g., oleamide, stearamide, erucamide or other derivatives with the same activity), and fillers (e.g., substantially spherical fillers having an aspect ratio of 1 to 3 like silica particle and titania particles). Preferably, the polyolefin film and/or polyolefin melt have an absence of particles or compositions having an aspect ratio greater than 3 aside from the in-situ formed elongated polyolefin structures of the film. As used herein, when the polyolefin film and/or polyolefin melt is described as having an absence of a material, the absence is an absence of material added relative to the manufactured polyolefin. For example, the first and second polyolefins, as manufactured, may have up to 2 wt % of particulates therein without any filler being added. The size and shape of such particulates depends on the manufacturing materials and process parameters.

Preferably, the polyolefin film and/or polyolefin melt contains less than 1 wt % of additives cumulatively, based on the total weight of the first and second polyolefins. When present, the amount of the additives cumulatively may range from a 0.01 wt % to 1 wt %, or 0.02 wt % to 0.5 wt %, or 0.05 wt % to 0.1 wt %. Preferably, the polyolefin film and/or polyolefin melt contains less than 1 wt % of added filler, based on the total weight of the first and second polyolefins. When present, the amount of added filler is less than 0.5 wt %, or less than 0.1 wt %, or less than 0.05 wt %, or less than 0.01 wt %. Preferably added filler is present at 0 wt %.

The films produced herein are typically initially formed by extrusion (such as cast extrusion) of a polymer melt comprising the first and second polyolefins. Then, the film is stretched at a temperature from 25° C. to below the melting point of the second polyolefin to form the elongated polyolefin structures in-situ in the film. Between forming and stretching the film, the film may be cooled (or quenched) or it may be maintained at elevated temperatures. Without being limited by theory, it is believed that cooling below the crystallization temperature of the second polyolefin after forming the film and before stretching may allow for the second polyolefin to crystallize and create nucleation/growth sites for the elongated polyolefin structures.

FIG. 2 illustrates a non-limiting example of a system 100 suitable for forming the films of the present disclosure having in-situ elongated polyolefin structures therein. An extruder 104 having a hopper 102 for adding a mixture of the first and second polyolefins as well as any optional additive included in the formulation. The extruder 104 illustrated has four temperature zones 104a-104d that may be at different temperatures suitable for melting and blending the first and second polyolefins. The resultant melt is extruded through a die 108, which is typically at an elevated temperature, and passed through a series of rollers 109-122 and 126-136. Generally, the extruded melt is cooled and stretched to form a film. However, in this instance, after the film 138a has cooled to below the crystallization temperature of the second polyolefin, the film is reheated with heating element 124 to a temperature from 25° C. to below the melting point of the second polyolefin and stretched using the rollers to form the elongated polyolefin structures in-situ in the film 138b. As illustrated, the heating element 124 is positioned between rollers 122 and 126.

Alternative to heating element 124 of FIG. 2, the rollers may be heated to different temperatures to provide the film heating and cooling steps. With reference to FIG. 2 without heating element 124, by way of non-limiting example, a system 100 may be operated at the polymer/film temperatures and roller speeds provided in Table 1. Because roller 122 and prior rollers 110-120 are all at the same speed and the following rollers 126-130 are at higher speed, the film stretches between rollers 122 and 126. Again, this is a non-limiting example and the stretching location, polymer/film temperatures, roller speeds, and other aspects of this example can be changed.

TABLE 1

| | Polymer/Film | Roller |
|---|---|---|
| Component | Temperature (° C.) | Speed (m/min) |
| Extruder zone 104a | 150 | n/a |
| Extruder zone 104b | 200 | n/a |
| Extruder zone 104c | 177 | n/a |
| Extruder zone 104d | 171 | n/a |
| Die 108 | 188 | n/a |
| Roller 110 | 90 | 1 |
| Roller 112 | 30 | 1 |
| Roller 118 | 70 | 1 |
| Roller 120 | 70 | 1 |
| Roller 122 | 80 | 1 |
| Roller 126 | 70 | >3 |
| Roller 128 | 30 | >3 |
| Roller 130 | 30 | >3 |

Referring back to FIG. 2 in a general manner (with or without heating element 124), FIG. 2 illustrates a system 100 that incorporates the in-situ formation of the elongated polyolefin structures with the extrusion and film forming. Other systems and methods can be implemented including forming the film on one system and then using rollers and heating elements in another system to form the elongated polyolefin structures in the film.

The film can be stretched while the film is at a temperature from 25° C. to below the melting point of the second polyolefin to form the elongated polyolefin structures in-situ in the film. The temperature may also be above 40° C. and below the melting point of the second polyolefin, or above 50° C. and below the melting point of the second polyolefin, or above 60° C. and below the melting point of the second polyolefin, or above 40° C. and below 5° C. below the melting point of the second polyolefin, or above 50° C. and below 5° C. below the melting point of the second polyolefin, or above 60° C. and below 5° C. below the melting point of the second polyolefin, or above 40° C. and below 10° C. below the melting point of the second polyolefin, or above 50° C. and below 10° C. below the melting point of the second polyolefin, or above 60° C. and below 10° C. below the melting point of the second polyolefin.

Without being limited by theory, it is believed that the temperature of stretching influences the length and the degree of misorientation of the elongated polyolefin structures in the film. For example, low temperatures may not allow the first polyolefin to soften enough to give the second polyolefins enough freedom of movement to orient in the stretch direction. Conversely, approaching the melting point of the second polyolefin may soften the second polyolefin such that its crystallinity is disrupted and it deforms, which may disrupt the orientation of the second polyolefin molecules in the stretch direction.

Before stretching, the film can be heated to the stretching temperature at a rate of 15° C./min to 100° C./min, or 30° C./min to 85° C./min, or 50° C./min to 75° C./min

The stretching rate can be 25 microns per second (μm/s) to 200 82 m/s, or 50 μm/s to 150 μm/s, or 75 μm/s to 125 μm/s.

Without being limited by theory, it is believed that the rate at which the film is heated before stretching, stretching rate, and the rate of quenching the film after heating and stretching may each also influence the length and the degree of misorientation of the elongated polyolefin structures in the film.

Typically the films are stretched in the machine direction (MD) at up to 800%, preferably from 100% to 800%, or 100% to 500%, or 100% and 300%, or 140 to 250%, or 175% to 225%.

Without being limited by theory, it is believed that higher concentrations of the second polyolefin may need to be stretched to a greater extent to produce the elongated polyolefin structures in situ. As used herein, “in situ” relative to the formation of elongated polyolefin structures refers to the structures that are formed while in the process of forming the final film and not structures that are preformed and then added as a separate component to the polymer melt.

After stretching, the film can be cooled (or quenched) to a temperature of 0° C. to 40° C., or 10° C. to 35° C., or 20° C. to 30° C., or room temperature. The film can be cooled at a rate of 15° C./min to 100° C./min, or 30° C./min to 85° C./min, or 50° C./min to 75° C./min Cooling can be with a cooled gas like air, liquid nitrogen, or other cryogenic gas.

The film having the elongated polyolefin structures therein may have a thickness of 10 microns to 150 microns, or 15 microns to 100 microns, or 25 microns to 75 microns. The film may contain one or more layers of the composition described herein, each of which may have a thickness of 10 microns to 150 microns, or 15 microns to 100 microns, or 25 microns to 75 microns.

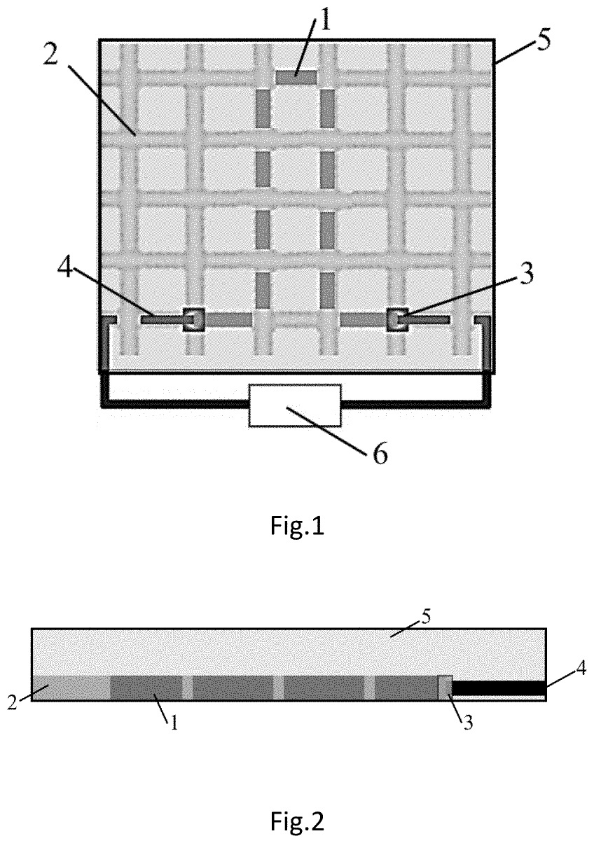

The presence of the elongated polyolefin structures can be observed using small angle x-ray scattering (SAXS). The film before stretching has a circular scattering pattern, also referred to as an isotropic scattering pattern, (FIG. 1A), which indicates a homogenous film having randomly oriented lamellar structures. Upon stretching, the appearance and growth of an equatorial streak (FIGS. 1B and 1C) implies formation of an elongated polyolefin structure. For a narrower full width at half max (FWHM) and a smaller spread in angle of these streaks, the longer and more oriented the elongated polyolefin structures are. For the methods and systems described herein, these structures are elongated polyolefin structures and not voids, which was confirmed with atomic force microscopy. The equatorial streak from streaked SAXS patterns can be analyzed using the Ruland streak method.

The elongated polyolefin structures may have a length (L) per the Ruland streak method analysis of the SAXS scattering patterns of 0.1 microns to 10 microns, or 0.25 microns to 8 microns, or 0.5 microns to 5 microns, or 0.25 microns to 3 microns, or 0.5 microns to 3.5 microns, or 1 micron to 5 microns.

The elongated polyolefin structures may have a degree of misorientation (B_{ϕ}) per the Ruland streak method analysis of the SAXS scattering patterns of 0.05 to 0.5, or 0.075 to 0.15, or 0.1 to 0.25, or 0.2 to 0.3. Lower values for the degree of misorientation indicates that the elongated polyolefin structures are more oriented in the machine direction.

The films described herein having elongated polyolefin structures therein formed by in-situ methods may be used as formed or may be laminated to other films or structures. For example, the films may be used as is or in other films/structures in a similar fashion to highly oriented films. Examples of applications where the films described herein having elongated polyolefin structures therein formed by in-situ methods may be useful may include, but are not limited to, packaging, agriculture films, construction films, bubble wrap, trash bags, and the like.

In another embodiment, one or more layers may be modified by corona treatment, electron beam irradiation, gamma irradiation, flame treatment, or microwave. In a preferred embodiment, one or both of the surface layers is modified by corona treatment.

### Example Embodiments

A non-limiting example embodiment is a method comprising: extruding a film from a polymer melt comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a reference polymer blend consisting of the first and second polyolefins in the same relative amounts as in the film has a multimodal (e.g., biomodal) differential scanning calorimetry melting profile above 40° C.; and stretching the film while the film is at a temperature from 25° C. to below the melting point of the second polyolefin to form elongated polyolefin structures in-situ in the film. This embodiment can further include one or more of the following: Element 1: wherein the second polyolefin is present at 0.1 wt % to 15 wt %; Element 2: the method further comprising: cooling the film after extruding and before stretching to below a crystallization temperature of the second polyolefin; Element 3: Element 2 and heating the film after cooling and before stretching at a rate of 30° C./min to 90° C./min up to the temperature from 25° C. to below the melting point of the second polyolefin; Element 4: the method further comprising: cooling the film after stretching to a temperature of 0° C. to 40° C.; Element 5: Element 4 and wherein cooling is at a rate of 15° C./min to 100° C./min; Element 6: wherein the stretching is at a stretching rate of 50 microns per second (um/s) to 200 um/s; Element 7: wherein the first polyolefin is a first ethylene polymer (homopolymer or copolymer) and the second polyolefin is a second ethylene polymer (homopolymer or copolymer); Element 8: wherein the first polyolefin is selected from the group consisting of a first ethylene homopolymer, a first propylene homopolymer, a first ethylene copolymer, and a first propylene copolymer, and wherein the second polyolefin is selected from the group consisting of a second ethylene homopolymer, a second propylene homopolymer, a second ethylene copolymer, and a second propylene copolymer; Element 9: wherein a blend of the first polyolefin and the second polyolefin at a consistent relative concentration as in the polymer melt has a monomodal molecular weight distribution; Element 10: wherein the elongated polyolefin structures have a length of 0.1 microns to 10 microns according to a Ruland streak method analysis of SAXS scattering data; Element 11: wherein the film has a degree of misorientation of 0.05 to 0.5 according to a Ruland streak method analysis of SAXS scattering data; and Element 12: wherein the polymer melt further comprises one or more additives selected from the group consisting of: a stabilization agent, an anti-static agent, a crosslink agent, a crosslink promoter, a release agent, an adhesion promoter, a plasticizer, and an anti-agglomeration agent. Examples of combinations include, but are not limited to, Element 1 in combination with one or more of Elements 2-12; Element 2 and optionally Element 3 in combination with Element 4 and optionally Element 5; one or more of Elements 2-5 in combination with one or more of Elements 7-12; and two or more of Elements 7-12 in combination.

Another non-limiting example embodiment is a film comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a reference polymer blend consisting of the first and second polyolefins in the same relative amounts as in the film has a multimodal (e.g., biomodal) differential scanning calorimetry melting profile above 40° C. This embodiment can further include one or more of the following: Element 1; Element 7; Element 8; Element 9; Element 10; Element 11; and Element 13: wherein the film further comprises one or more additives selected from the group consisting of: a stabilization agent, an anti-static agent, a crosslink agent, a crosslink promoter, a release agent, an adhesion promoter, a plasticizer, and an anti-agglomeration agent. Examples of combinations include, but are not limited to, Element 1 in combination with one or more of Elements 7-11 and 13; and two or more of Elements 7-11 and 13 in combination.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

This invention relates to compositions comprising two or more polyolefins, optionally formed in to films, where the composition comprises:
1) 99.9 to 70 wt % (or about 99 wt % to about 80 wt %, or about 95 wt % to about 85 wt %, or about 99.9 wt % to about 85 wt %) of a first polyolefin having:
   i) a density of 0.850 g/cm³ to 0.930 g/cm³ (or 0.860 g/cm³ to 0.910 g/cm³, or 0.880 g/cm³ to 0.900 g/cm³),
   ii) a melt flow index of 0.2 g/10 min to 10 g/10 min (or 0.4 to 6 g/10 min, or of 0.5 to 3 g/10 min), and
   iii) a melting temperature (Tm) of about 50° C. to about 180° C. (or about 60° C. to about 175° C., or about 70° C. to about 170° C., or about 50° C. to about 100° C., or about 60° C. to about 95° C., or about 70° C. to about 90° C., or about 70° C. to about 180° C., or about 90° C. to about 175° C., or about 100° C. to about 170° C.); and
2) 0.1 wt % to 30 wt % (or about 1 wt % to about 20 wt %, or about 5 wt % to about 15 wt %, or about 0.1 wt % to about 15 wt %) of a second polyolefin having:
   i) a density of 0.890 g/cm³ to 0.970 g/cm3 (or 0.910 g/cm³ to 0.970 g/cm³, or 0.930 g/cm³ to 0.960 g/cm³), wherein the density of the second polyolefin is at least 0.04 g/cm³ (or at least 0.055 g/cm³, or 0.04 g/cm³ to 0.12 g/cm³, or 0.05 g/cm³ to 0.10 g/cm³) greater than the density of the first polyolefin,
   ii) a melt flow index of 0.2 g/10 min to 10 g/10 min (or 0.4 to 6 g/10 min, or 0.5 to 3 g/10 min)
   iii) a Tm of 80° C. to about 200° C. (or about 90° C. to about 190° C., or about 100° C. to about 185° C., or about 80° C. to about 150° C., or about 90° C. to about 145° C., or about 100° C. to about 140° C., or about 100° C. to about 200° C., or about 120° C. to about 190° C., or about 140° C. to about 185° C.); and
wherein:
   I) the melt flow index of the first polyolefin is within 25% (preferably within 20%, (preferably within 0.01% to 25%, or within 1% to 20%, or within 10% to 15% or within 5% to 10%, preferably within 0% to 5%) of the melt flow index of the second polyolefin,
   II) a reference polymer blend consisting of the first and second polyolefins in the same relative amounts as in the composition has a multimodal (e.g., bimodal) differential scanning calorimetry melting profile above 40° C. (or above 50° C., or above 60° C., or above 70° C., or above 80° C.),
   III) the Tm of the second polyolefin minus the Tm of the first polyolefin is about 25° C. to about 100° C. (or about 35° C. to about 85° C., or about 45° C. to about 65° C.),
   IV) the composition is preferably present in a molten or solid state, and
   V) optionally, the composition contains less than 1 wt % of added filler, based on the total weight of the first and second polyolefins.

This invention also relates to a method to form a film comprising:
A) forming a molten composition comprising two or more polyolefins into a film, where the composition comprises:
   1) 99.9 to 70 wt % (or about 99 wt % to about 80 wt %, or about 95 wt % to about 85 wt %, or about 99.9 wt % to about 85 wt %) of a first polyolefin having:
      i) a density of 0.850 g/cm³ to 0.930 g/cm³ (or 0.860 g/cm³ to 0.910 g/cm³, or 0.880 g/cm³ to 0.900 g/cm³),
      ii) a melt flow index of 0.2 g/10 min to 10 g/10 min (or 0.4 to 6 g/10 min, or of 0.5 to 3 g/10 min), and
      iii) a melting temperature (Tm) of about 50° C. to about 180° C. (or about 60° C. to about 175° C., or about 70° C. to about 170° C., or about 50° C. to about 100° C., or about 60° C. to about 95° C., or about 70° C. to about 90° C., or about 70° C. to about 180° C., or about 90° C. to about 175° C., or about 100° C. to about 170° C.); and
   2) 0.1 wt % to 30 wt % (or about 1 wt % to about 20 wt %, or about 5 wt % to about 15 wt %, or about 0.1 wt % to about 15 wt %) of a second polyolefin having:
      i) a density of 0.890 g/cm³ to 0.970 g/cm3 (or 0.910 g/cm³ to 0.970 g/cm³, or 0.930 g/cm³ to 0.960 g/cm³), wherein the density of the second polyolefin is at least 0.04 g/cm³ (or at least 0.055 g/cm³, or 0.04 g/cm³ to 0.12 g/cm³, or 0.05 g/cm³ to 0.10 g/cm³) greater than the density of the first polyolefin,
      ii) a melt flow index of 0.2 g/10 min to 10 g/10 min (or 0.4 to 6 g/10 min, or 0.5 to 3 g/10 min)
      iii) a Tm of 80° C. to about 200° C. (or about 90° C. to about 190° C., or about 100° C. to about 185° C., or about 80° C. to about 150° C., or about 90° C. to about 145° C., or about 100° C. to about 140° C., or about 100° C. to about 200° C., or about 120° C. to about 190° C., or about 140° C. to about
   wherein:
      I) the melt flow index of the first polyolefin is within 25% (preferably within 20%, (preferably within 0.01% to 25%, or within 1% to 20%, or within 10% to 15% or within 5% to 10%, preferably within 0% to 5%) of the melt flow index of the second polyolefin,
      II) a reference polymer blend consisting of the first and second polyolefins in the same relative amounts as in the composition has a multimodal (e.g., bimodal) differential scanning calorimetry melting profile above 40° C. (or above 50° C., or above 60° C., or above 70° C., or above 80° C.),
      III) the Tm of the second polyolefin minus the Tm of the first polyolefin is about 25° C. to about 100° C. (or about 35° C. to about 85° C., or about 45° C. to about 65° C.),
      IV) the composition is preferably present in a molten or solid state, and
      V) optionally, the composition contains less than 1 wt % of added filler, based on the total weight of the first and second polyolefins.
B) thereafter stretching the film up to 800% (or100% to 800%, or 100% to 500%, or 100% and 300%, or 140 to 250%, or 175% to 225%) at 25 um/s to 200 um/s (or 50 um/s to 150 um/s, or 75 um/s to 125 um/s) while the film is at a temperature is from 25° C. (or from 40° C., or from 50° C., or from 60° C.) to below the Tm of the second polyolefin (preferably at least 5° C. below the Tm of the second polyolefin, preferably at least 10° C. below the Tm of the second polyolefin, preferably at least 25° C. below the Tm of the second polyolefin, preferably at least 35° C. below the Tm of the second polyolefin, preferably at least 45° C. below the Tm of the second polyolefin, preferably at least 50° C. below the Tm of the second polyolefin) to form elongated polyolefin structures in the film,
C) optionally, before stretching in step B), the film can be heated to the stretching temperature at a rate of 15° C./min to 100° C./min, or 30° C./min to 85° C./min, or 50° C./min to 75° C./min;
D optionally after stretching in step B), the film can be cooled or quenched to a temperature of 0° C. to 40° C. (or 10° C. to 35° C., or 20° C. to 30° C., or room temperature) at a rate of 15° C./min to 100° C./min (or 30° C./min to 85° C./min, or 50° C./min to 75 ° C./min);
   wherein the elongated polyolefin structures have:
      I) a length of 0.1 microns to 10 microns, and
      II) a degree of misorientation of 0.05 to 0.5.

The invention also relates to Embodiment A1, which is a method comprising:
1) extruding a film from a polymer melt comprising a first polyolefin and 0.1 wt % to 30 wt % of a second polyolefin, relative to a total weight of the first and second polyolefins, wherein the second polyolefin has a density of at least 0.04 g/cm³ greater than a density of the first polyolefin, wherein the melt flow index of the first polyolefin is within 25% of the melt flow index of the second polyolefin, and wherein a reference polymer blend consisting of the first and second polyolefins in the corresponding relative amounts as in the film has a multimodal differential scanning calorimetry melting profile above 40° C.; and
2) stretching the film while the film is at a temperature above 25° C. and below the melting point of the second polyolefin to form elongated polyolefin structures in-situ in the film.

The invention also relates to Embodiment A2, which is the method of Embodiment A1, wherein the second polyolefin is present at 0.1 wt % to 15 wt %.

The invention also relates to Embodiment A3, which is the method of Embodiment A1 or A2 further comprising: a) cooling the film after extruding in step 1) and before stretching in step 2) to below the crystallization temperature of the second polyolefin.

The invention also relates to Embodiment A4, which is the method of Embodiment A3 further comprising: heating the film, after cooling in step la) and before stretching in step 2), at a rate of 30° C./min to 90° C./min up to the temperature above 25° C. and below the melting point of the second polyolefin.

The invention also relates to Embodiment A5, which is the method of any of Embodiments A1-A4 further comprising: cooling the film after stretching in step 2) to a temperature of 0° C. to 40° C.

The invention also relates to Embodiment A6, which is the method of Embodiment A5, wherein cooling is at a rate of 15° C./min to 100° C./min

The invention also relates to Embodiment A7, which is the method of any of Embodiments A1-A6, wherein the stretching is at a stretching rate of 50 microns per second (um/s) to 200 um/s.

The invention also relates to Embodiment A8, which is the method of any of Embodiments A1-A7, wherein the film is stretch up to 800% in a machine direction.

The invention also relates to Embodiment A9, which is the method of any of Embodiments A1-A8, wherein the first polyolefin is a first ethylene polymer and the second polyolefin is a second ethylene polymer.

The invention also relates to Embodiment A10, which is the method of any of Embodiments A1-A9, wherein the reference blend has a monomodal molecular weight distribution.

The invention also relates to Embodiment A11, which is the method of any of Embodiments A1-A10, wherein the elongated polyolefin structures have a length of 0.1 microns to 10 microns according to a Ruland streak method analysis of SAXS scattering data.

The invention also relates to Embodiment A12, which is the method of any of Embodiments A1-A11, wherein the film has a degree of misorientation of 0.05 to 0.5 according to a Ruland streak method analysis of SAXS scattering data.

The invention also relates to Embodiment A13, which is the method of any of Embodiments A1-A12, wherein the polymer melt further comprises one or more additives selected from the group consisting of: a stabilization agent, an anti-static agent, a crosslink agent, a crosslink promoter, a release agent, an adhesion promoter, a plasticizer, and an anti-agglomeration agent.

The invention also relates to Embodiment B1, which is a composition comprising: a film comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a polymer blend consisting of the first and second polyolefins in the corresponding relative amounts as in the film, reference blend, has a multimodal differential scanning calorimetry melting profile above 40° C., wherein elongated polyolefin structures are present in the film.

The invention also relates to Embodiment B2, which is the composition of Embodiment B1, wherein the first polyolefin is a first ethylene polymer and the second polyolefin is a second ethylene polymer.

The invention also relates to Embodiment B3, which is the composition of Embodiment B1 or B2, wherein the reference blend has a monomodal molecular weight distribution.

The invention also relates to Embodiment B4, which is the composition of any of Embodiments B1-B3, wherein the elongated polyolefin structures have a length of 0.1 microns to 10 microns according to a Ruland streak method analysis of SAXS scattering data.

The invention also relates to Embodiment B5, which is the composition of any of Embodiments B1-B34 wherein the film has a degree of misorientation of 0.05 to 0.5 according to a Ruland streak method analysis of SAXS scattering data.

The invention also relates to Embodiment B6, which is the composition of any of Embodiments B1-B5, wherein the film further comprises one or more additives selected from the group consisting of: a stabilization agent, an anti-static agent, a crosslink agent, a crosslink promoter, a release agent, an adhesion promoter, a plasticizer, and an anti-agglomeration agent.

This invention further relates to:
1. A method comprising:

1) extruding a film from a polymer melt comprising a first polyolefin and 0.1 wt % to 30 wt % of a second polyolefin, relative to a total weight of the first and second polyolefins, wherein the second polyolefin has a density of at least 0.04 g/cm³ greater than a density of the first polyolefin, wherein the melt flow index of the first polyolefin is within 25% of the melt flow index of the second polyolefin, and wherein a reference polymer blend consisting of the first and second polyolefins in the same relative amounts as in the film has a multimodal differential scanning calorimetry melting profile above 40° C.; and

2) stretching the film while the film is at a temperature from 25° C. to below the melting point of the second polyolefin to form elongated polyolefin structures in-situ in the film.
2. The method of paragraph 1, wherein the second polyolefin is present at 0.1 wt % to 15 wt %.
3. The method of paragraph 1 or 2 further comprising:

1a) cooling the film after extruding in step 1) and before stretching in step 2) to below the crystallization temperature of the second polyolefin.
4. The method of paragraph 3 further comprising:

heating the film, after cooling in step 1a) and before stretching in step 2), at a rate of 30° C./min to 90° C./min up to the temperature from 25° C. to below the melting point of the second polyolefin.
5. The method of any preceding paragraph further comprising: cooling the film after stretching in step 2) to a temperature of 0° C. to 40° C.
6. The method of paragraph 5, wherein cooling is at a rate of 15° C./min to 100° C./min.
7. The method of any preceding paragraph, wherein the stretching is at a stretching rate of 50 microns per second (um/s) to 200 um/s.
8. The method of any preceding paragraph, wherein the film is stretch up to 800% in a machine direction.
9. The method of any preceding paragraph, wherein the first polyolefin is a first ethylene polymer and the second polyolefin is a second ethylene polymer.
10. The method of any preceding paragraph, wherein the reference blend has a monomodal molecular weight distribution.
11. The method of any preceding paragraph, wherein the elongated polyolefin structures have a length of 0.1 microns to 10 microns according to a Ruland streak method analysis of SAXS scattering data.
12. The method of any preceding paragraph, wherein the film has a degree of misorientation of 0.05 to 0.5 according to a Ruland streak method analysis of SAXS scattering data.
13. The method of any preceding paragraph, wherein the polymer melt further comprises one or more additives selected from the group consisting of: a stabilization agent, an anti-static agent, a crosslink agent, a crosslink promoter, a release agent, an adhesion promoter, a plasticizer, and an anti-agglomeration agent.
14. A composition comprising:

a film comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a reference polymer blend consisting of the first and second polyolefins in the same relative amounts as in the film, reference blend, has a multimodal differential scanning calorimetry melting profile above 40° C., wherein elongated polyolefin structures are present in the film.
15. The composition of paragraph 14, wherein the first polyolefin is a first ethylene polymer and the second polyolefin is a second ethylene polymer.
16. The composition of paragraph 14 or 15, wherein the reference blend has a monomodal molecular weight distribution.
17. The composition of any of paragraphs 14 to 16, wherein the elongated polyolefin structures have a length of 0.1 microns to 10 microns according to a Ruland streak method analysis of SAXS scattering data.
18. The composition of any of paragraphs 14 to 17, wherein the film has a degree of misorientation of 0.05 to 0.5 according to a Ruland streak method analysis of SAXS scattering data.
19. The composition of any of paragraphs 14 to 18, wherein the film further comprises one or more additives selected from the group consisting of: a stabilization agent, an anti-static agent, a crosslink agent, a crosslink promoter, a release agent, an adhesion promoter, a plasticizer, and an anti-agglomeration agent.
20. A method to form a film comprising:

A) forming a polymer melt comprising two or more polyolefins into a film, wherein the polymer melt comprises:
1) 99.9 wt % to 70 wt % of a first polyolefin having:
   i) a density of 0.850 g/cm³ to 0.930 g/cm³,
   ii) a melt flow index of 0.2 g/10 min to 10 g/10 min, and
   iii) a melting temperature™ of about 50° C. to about 100° C.; and
2) 0.1 wt % to 30 wt % of a second polyolefin having:
   i) a density of 0.890 g/cm³ to 0.970 g/cm³, where the density is at least 0.04 g/cm³ greater than the density of the first polyolefin,
   ii) a melt flow index of 0.2 g/10 min to 10 g/10 min, and
   iii) a Tm of about 80° C. to about 150° C.;

wherein:
I) the melt flow index of the first polyolefin is within 25% of the melt flow index of the second polyolefin,
II) a reference polymer blend consisting of the first and second polyolefins in the same relative amounts as in the composition has a multimodal differential scanning calorimetry melting profile where all peaks are above 40° C.,
III) a melting temperature of the second polyolefin minus a melting temperature of the first polyolefin is about 25° C. to about 100° C.,
IV) the polymer melt is present in a molten state, and
V) optionally, the polymer melt contains less than 1 wt % of added filler, based on the total weight of the first and second polyolefins; and

B) thereafter stretching the film up to 800% in a machine direction at 25 um/s to 200 um/s while the film is at a temperature from 25° C. to below the Tm of the second polyolefin to form elongated polyolefin structures in the film;

C) optionally, before stretching in step B), the film can be heated to the stretching temperature at a rate of 15° C./min to 100° C./min; and

D) optionally after stretching in step B), the film can be cooled or quenched to a temperature of 0° C. to 40° C. at a rate of 15° C./min to 100° C./min;

wherein the elongated polyolefin structures have:
I) a length of 0.1 microns to 10 microns, and
II) a degree of misorientation of 0.05 to 0.5.

To facilitate a better understanding of the embodiments of the present invention, the following examples of preferred or representative embodiments are given. In no way should the following examples be read to limit, or to define, the scope of the invention.

### EXAMPLES

Two polymers were produced in a gas phase polymerization process in co-pending application U.S. Ser. No. 62/760,282 filed Nov. 13, 2018 (attorney docket number 2018EM318), examples D1 (POLYA) and D5 (POLYB) are used herein. Characterization data reported in U.S. Ser. No. 62/760,282 are reproduced below in Table 3.

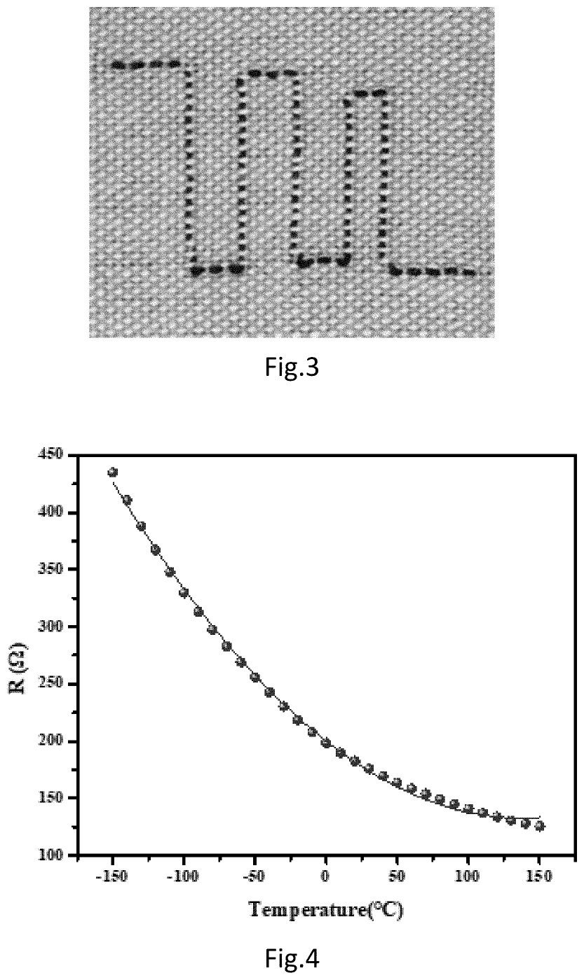

Three polymer blends were produced according to Table 2 where PolyA is an ethylene-hexene copolymer (MI 1.03 g/10 min, density 0.895 g/cm³, Tm 81.7° C.), and PolyB is an ethylene-hexene copolymer(MI 0.85 g/10 min, a density 0.952 g/cm³, Tm 135.8° C.). Each of PolyA and PolyB have compounded therein: IRGANOX® 1076 (1000 ppm) (octadecyl 3-3,5-di-tert-butyl-4-hydroxyphenyl)propionate, an antioxidant, available from BASF), IRGAFOS® 168 (1200 ppm) (tris(2,4-di-tert-butylphenyl)phosphite, available from BASF), and DYNAMAR™ FX5920A (660 ppm) (a fluoropolymer based processing additive, available from 3M). Further, FIG. 3 is the DSC melting and crystallization profiles for the individual PolyA and PolyB and a blend of PolyA:PolyB at a weight ratio of 90:10.

TABLE 2
Blend properties

| Weight Ratio of | Melt Index | Density | Melting Peaks |
|---|---|---|---|
| PolyA:PolyB | (g/10 min) | (g/cm³) | (° C.) |
| 90:10 | 0.99 | 0.905 | 1^{st} = 82.7, 2^{nd} = 127.5 |
| 70:30 | 0.97 | 0.912 | 1^{st} = 82.2, 2^{nd} = 129.6 |
| 50:50 | 0.96 | 0.922 | 1^{st} = 82, 2^{nd} = 131.7 |

TABLE 3

| | | | PolyB |
|---|---|---|---|
| Components | | PolyA | (n-PrCp)₂HfMe₂ |
| Catalyst | | (Cp)(PrMe₄Cp)HfCl₂ | supported on ES70 silica |
| MI | (dg/min) | 0.99 | 0.86 |
| HLMI | (dg/min) | 16.1 | 14.6 |
| MIR | (I₂₁/I₂) | 16.3 | 17.0 |
| Density | (g/cm³) | 0.8949 | 0.9518 |
| Vinylene | (/1000 C) | 0.01 | 0.06 |
| TSO | (/1000 C) | 0.01 | 0.01 |
| Vinylene | (/1000 C) | 0.01 | 0.01 |
| Vinylidene | (/1000 C) | 0.01 | 0.00 |
| Total Unsat | (/1000 C) | 0.04 | 0.08 |
| methyl w/o CE Correction | (/1000 C) | 31.2 | 1.2 |
| Mn GPC4D | (g/mol) | 46,263 | 40,424 |
| Mw GPC4D | (g/mol) | 119,352 | 124,722 |
| Mz GPC4D | (g/mol) | 201,808 | 259,215 |
| Mz + 1 | (g/mol) | 298,058 | 477,363 |
| Mw/Mn GPC4D | | 2.6 | 3.1 |
| Mz/Mw GPC4D | | 1.7 | 2.1 |
| Hexene | (wt %) | 18.7 | 0.7 |
| g′(Vis Ave.) | | 0.98 | 1.05 |
| Recover | (%) | 101% | 100% |
| SF Weight Fraction | (%) | 1.06 | 0.21 |
| Tw TREF | (° C.) | 54.36 | 96.62 |
| Tn TREF | (° C.) | 49.3 | 92.15 |
| T75-T25 | (° C.) | 10.8 | 1.1 |

To make the blends, PolyA and PolyB in the prescribed weight ratio were mixed on the BRABENDER® 3 Zone Electric Mixer (dry) at 200° C. for 5 minutes at a mixer speed of 80 rpm. PolyA and PolyB were present in granules and pellets, respectively.

After mixing, the polymer blend was molded in a dog-bone shape by compression molding at 177° C. Samples were initially pressed for 3 minutes with a low pressure of 3,500 tons and afterwards a higher pressure of 25,000 tons was applied. A cooling rate of 15° C./min. was used. After completion, the molded plaques were removed from the press and trimmed off flashing in dog-bone shaped specimen.

The dog-bone specimens were then heated and stretched while rheology and SAXS data was collected to identify the in-situ formation of elongated polyethylene structures. A Linkam tensile stage was used to stretch the dog-bone specimens. More specifically, the specimens were loaded in the Linkam stage between two clamps, pre-stretched at 10 um/s until the axial force became positive but below 0.5 N. While still in the stage, the pre-stretched specimens were then preheated for 30 seconds at a target temperature (25° C., 70° C., and 80° C.). Then, a constant stretching rate of 100 um/s was applied until a final strain of 200% was achieved. After stretching, the specimens while still in the stage were quenched to room temperature (about 25° C.) at a rate of 60° C./min. Quenching was performed at a rate of 60° C./min using liquid nitrogen. Finally, the stretched samples were maintained at room temperature for 3 minutes. After preheating and during heating, stretching, and cooling, SAXS data was collected to access the microstructural information of the sample.

Three target temperatures were investigated: 25° C., 70° C., and 80° C.

FIG. 4 is a photograph of the final stretched specimen for the 90:10 specimen at the three temperatures investigated. Stretching at higher temperatures yield a longer, thinner stretched section.

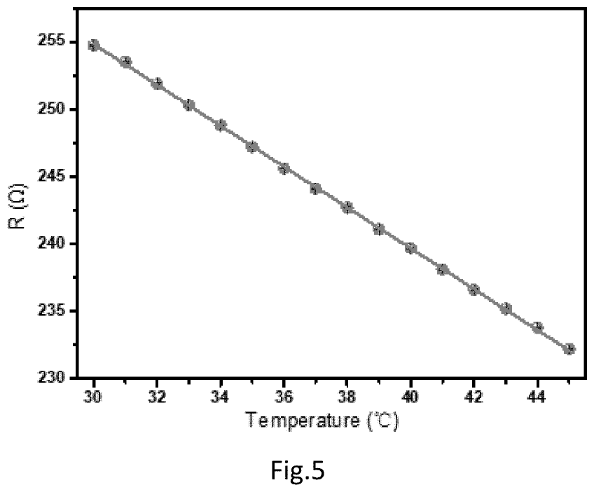

FIG. 5 includes a plot of the stress as a function of time during stretching of the specimen for the 90:10 specimen at 80° C. along with SAXS scattering pattern data corresponding to five time points during the stretching, during cooling, and after cooling. The plot indicates that the specimen undergoes strain hardening. SAXS Scan A is at the beginning and illustrates a circular scattering pattern. As stretching continues through SAXS Scans B and C, an oblong scattering pattern forms. With further stretching and cooling through SAXS Scans D and E, a streaked scattering pattern forms and becomes better defined. The progression of the SAXS scattering patterns indicates that elongated structures are forming in-situ as the specimen is being stretched. Further, the progression to a clear, streaked scattering pattern indicates that the elongated structures have a lower degree of misorientation.

The Ruland streak method was used to analyze SAXS Scans D and E. The Ruland streak method analysis SAXS Scan D (during strain hardening) yields a 2.0 um length of the elongated polyethylene structures and a 0.11 degree of misorientation. The Ruland streak method analysis SAXS Scan D (during cooling) yields a 3.7 um length of the elongated polyethylene structures and a 0.11 degree of misorientation. Without being limited by theory, the growth in length may be due to additional polymer molecules crystallizing around the already formed elongated polyethylene structures during the cooling.

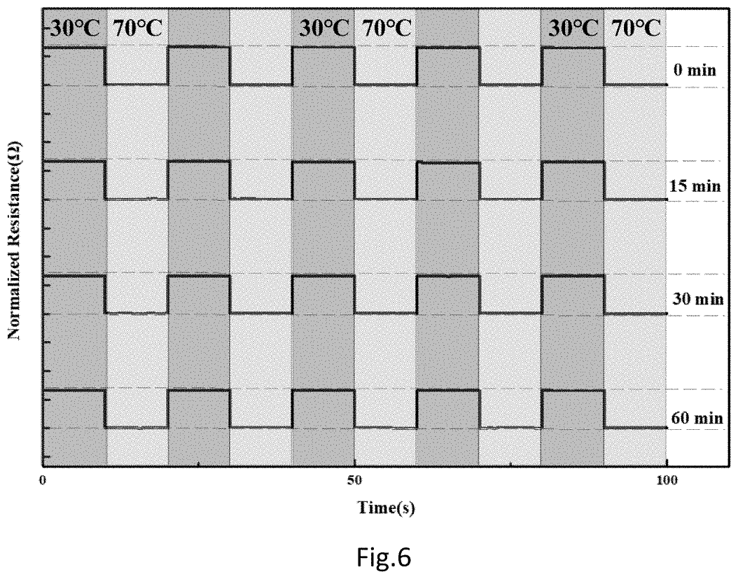

Similar analyses were performed on the 90:10 specimen stretched at 25° C. and 70° C. FIG. 6 is a plot of the stress as a function of time during stretching of the specimen for the 90:10 specimen at the three stretching temperatures. This illustrates that each sample undergoes strain hardening during stretching.

Table 4 provides the Ruland streak method analysis SAXS scans for these temperatures and 80° C. at similar data points to Scans D and E of the 80° C. stretched specimen. This analysis illustrates that elongated polyethylene structures are formed at various stretching temperatures. Further, higher temperatures produce longer, more aligned elongated polyethylene structures.

TABLE 4

| | | Length of the | |
|---|---|---|---|
| | | Elongated | |
| Stretching | | Polyethylene | Degree of |
| Temperature | SAXS Scan | Structures (μm) | Misorientation |
| 25° C. | during strain hardening | 0.64 | 0.24 |
| | during cooling | 0.97 | 0.26 |
| 70° C. | during strain hardening | 1.1 | 0.12 |
| | during cooling | 2.7 | 0.11 |
| 80° C. | during strain hardening | 2.0 | 0.11 |
| | during cooling | 3.7 | 0.11 |

Atomic force microscopy (AFM) was further used to analyze the stretched samples. Herein, phase 2 data are provided. Phase 2 data is a measure of the hardness of a surface where darker portions are harder. Without being limited by theory, it is believed that the harder portions of the phase 2 data are the elongated polyethylene structures. Samples were prepared for AFM by cryo-microtoming the specimen.

FIG. 7A includes representative 2-D and 3-D phase 2 AFM scans of the 25° C. stretched specimen. FIG. 7B includes representative 2-D and 3-D phase 2 AFM scans of the 70° C. stretched specimen. FIG. 7C includes representative 2-D and 3-D phase 2 AFM scans of the 80° C. stretched specimen.

The AFM data further supports the SAXS data that with higher temperatures, the elongated polyethylene structures become longer, more aligned. Further, the AFM data confirms that the equatorial streaks are a result of elongated polyethylene structure formation and not void formation.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

All documents described herein are incorporated by reference herein, including any priority documents and/or testing procedures to the extent they are not inconsistent with this text.

The invention claimed is:

1. A method comprising:
1) extruding a film from a polymer melt comprising a first polyolefin and 0.1 wt % to 30 wt % of a second polyolefin, relative to a total weight of the first and second polyolefins, wherein the second polyolefin has a density of at least 0.04 g/cm³ greater than a density of the first polyolefin, wherein the melt flow index of the first polyolefin is within 25% of the melt flow index of the second polyolefin, and wherein a reference polymer blend consisting of the first and second polyolefins in the same relative amounts as in the film has a multimodal differential scanning calorimetry melting profile above 40° C.; and
2) stretching the film while the film is at a temperature from 25° C. to below the melting point of the second polyolefin to form elongated polyolefin structures in-situ in the film.

2. The method of claim 1, wherein the second polyolefin is present at 0.1 wt % to 15 wt %.

3. The method of claim 1 further comprising:
1a) cooling the film after extruding in step 1) and before stretching in step 2) to below the crystallization temperature of the second polyolefin.

4. The method of claim 3 further comprising:
heating the film, after cooling in step 1a) and before stretching in step 2), at a rate of 30° C./min to 90° C./min up to the temperature from 25° C. to below the melting point of the second polyolefin.

5. The method of claim 1, further comprising:
cooling the film after stretching in step 2) to a temperature of 0° C. to 40° C.

6. The method of claim 5, wherein cooling is at a rate of 15° C./min to 100° C./min.

7. The method of claim 1, wherein the stretching is at a stretching rate of 50 microns per second (μm/s) to 200 μm/s.

8. The method of clam 1, wherein the film is stretch up to 800% in a machine direction.

9. The method of claim 1, wherein the first polyolefin is a first ethylene polymer and the second polyolefin is a second ethylene polymer.

10. The method of claim 1, wherein the reference blend has a monomodal molecular weight distribution.

11. The method of claim 1, wherein the elongated polyolefin structures have a length of 0.1 microns to 10 microns according to a Ruland streak method analysis of SAXS scattering data.

12. The method of claim 1, wherein the film has a degree of misorientation of 0.05 to 0.5 according to a Ruland streak method analysis of SAXS scattering data.

13. The method of claim 1, wherein the polymer melt further comprises one or more additives selected from the group consisting of: a stabilization agent, an anti-static agent, a crosslink agent, a crosslink promoter, a release agent, an adhesion promoter, a plasticizer, and an anti-agglomeration agent.

14. A composition comprising:
a film comprising a first polyolefin and 0.1 wt % to 30 wt % of a second polyolefin, wherein the second polyolefin has a density of at least 0.04 g/cm³ greater than a density of the first polyolefin, wherein a melt flow index of the first polyolefin is within 25% of a melt flow index of the second polyolefin, and wherein a reference polymer blend consisting of the first and second polyolefins in the same relative amounts as in the film, reference blend, has a multimodal differential scanning calorimetry melting profile above 40° C., wherein elongated polyolefin structures are present in the film.

15. The composition of claim 14, wherein the first polyolefin is a first ethylene polymer and the second polyolefin is a second ethylene polymer.

16. The composition of claim 14, wherein the reference blend has a monomodal molecular weight distribution.

17. The composition of claim 14, wherein the elongated polyolefin structures have a length of 0.1 microns to 10 microns according to a Ruland streak method analysis of SAXS scattering data.

18. The composition of claim 14, wherein the film has a degree of misorientation of 0.05 to 0.5 according to a Ruland streak method analysis of SAXS scattering data.

19. The composition of claim 14, wherein the film further comprises one or more additives selected from the group consisting of: a stabilization agent, an anti-static agent, a crosslink agent, a crosslink promoter, a release agent, an adhesion promoter, a plasticizer, and an anti-agglomeration agent.

20. A method to form a film comprising:
A) forming a polymer melt comprising two or more polyolefins into a film, wherein the polymer melt comprises:
1) 99.9 wt % to 70 wt % of a first polyolefin having:
i) a density of 0.850 g/cm³ to 0.930 g/cm³,
ii) a melt flow index of 0.2 g/10 min to 10 g/10 min, and
iii) a melting temperature Tm of about 50° C. to about 100° C.; and
2) 0.1 wt % to 30 wt % of a second polyolefin having:
i) a density of 0.890 g/cm³ to 0.970 g/cm³, where the density is at least 0.04 g/cm³ greater than the density of the first polyolefin,
ii) a melt flow index of 0.2 g/10 min to 10 g/10 min, and
iii) a Tm of about 80° C. to about 150° C.;
wherein:
I) the melt flow index of the first polyolefin is within 25% of the melt flow index of the second polyolefin,
II) a reference polymer blend consisting of the first and second polyolefins in the same relative amounts as in the composition has a multimodal differential scanning calorimetry melting profile where all peaks are above 40° C.,
III) a melting temperature of the second polyolefin minus a melting temperature of the first polyolefin is about 25° C. to about 100° C.,
IV) the polymer melt is present in a molten state, and
V) optionally, the polymer melt contains less than 1 wt % of added filler, based on the total weight of the first and second polyolefins; and
B) thereafter stretching the film up to 800% in a machine direction at 25 μm/s to 200 μm/s while the film is at a temperature from 25° C. to below the Tm of the second polyolefin to form elongated polyolefin structures in the film;
C) optionally, before stretching in step B), the film can be heated to the stretching temperature at a rate of 15° C./min to 100° C./min; and
D) optionally after stretching in step B), the film can be cooled or quenched to a temperature of 0° C. to 40° C. at a rate of 15° C./min to 100° C./min;
wherein the elongated polyolefin structures have:
I) a length of 0.1 microns to 10 microns, and
II) a degree of misorientation of 0.05 to 0.5.
